(19) United States
(12) Patent Application Publication
(10) Pub. No.: US 2002/0178088 A1
(43) Pub. Date: Nov. 28, 2002

(54) System and method for facilitating shopping

(76) Inventors: Leib A. Lurie, Troy, OH (US); William Heckle, Menomonee Falls, WI (US); Angela Manning, Troy, OH (US); Derek Diperna, Princeton, NJ (US); William Jackson, Lansdale, PA (US)

Correspondence Address: LAW OFFICES OF DAVID MCEWING, 4582 KINGWOOD DRIVE, BOX 118, KINGWOOD, TX, 77345, US

(21) Appl. No.: 10/193,459

(22) Filed: Jul. 11, 2002

Related U.S. Application Data
(63) Continuation-in-part of application No. 09/521,244, filed on Mar. 8, 2000.
(60) Provisional application No. 60/348,849, filed on Jan. 14, 2002.
(60) Provisional application No. 60/348,443, filed on Jan. 14, 2002.

(51) Int. Cl. G06F 17/60

(52) U.S. Cl. 705/26

(57) ABSTRACT

Purchase of items is facilitated though use of a wireless device. The wireless device connects to a server via a global communications network. The consumer's shopping list is maintained on the server and displayed on the wireless device. Using the wireless device and the shopping list, a checkout list is created by entering or scanning codes on selected items at locations proximate the selected items in a store. One or more of the locations proximate the selected items corresponds to a location that is different from a point of sale in the store, the point of sale corresponding to a location in the store where goods on the checkout list are purchased using the wireless device.

### CROSS REFERENCE TO RELATED APPLICATIONS

This application is a continuation-in-part of U.S. patent application Ser. No. 09/521,244, filed Mar. 8, 2000, and claims the benefit of U.S. Provisional Application Nos. 60/348,849 and 60/348,443, filed Jan. 14, 2002.

### FIELD OF THE INVENTION

The invention relates generally to facilitating purchase of items from a retail or wholesale outlet, such as a grocery store, using a wireless device.

### BACKGROUND OF INVENTION

Shopping, and in particular grocery shopping, is an activity most consumers experience on a weekly basis. Thus, any method or system designed to make the shopping experience more efficient would be valued by the consumer. Creating, maintaining and using lists of items to purchase; learning about in-store specials and other promotions; learning about product ingredients and including payment, are just some of the activities with regard to which improvement and innovation are needed.

### SUMMARY OF THE INVENTION

The present invention is directed to a method and system for facilitating purchase of one or more items using a wireless scanning device. The wireless scanning device connects to a server via a global communications network. The shopping list is maintained on the server and displayed on the wireless scanning device. Using the wireless scanning device and the shopping list, a checkout list is created by scanning codes on selected items at locations proximate the selected items in a store. One or more of the locations proximate the selected items corresponds to a location that is different from a point of sale in the store, the point of sale corresponding to a location in the store where goods on the checkout list are purchased using the wireless scanning device.

In another aspect of the present invention, an alternative to paying for items selected for purchase in a conventional manner (e.g., cash payment to a cashier or swiping a credit or debit card at the point of sale terminal) is presented. A purchase price authorization for the items to be purchased is transmitted over a global communications network by an end user to a remote server using a wireless device. The purchase price authorization includes some manner of identifying the end user and price information. The purchase price authorization is stored at the remote server. A request seeking authorization for payment of the items selected for purchase is received at the remote server from a point of sale terminal. The request includes the end user identification information and the price information. The purchase price authorization is transmitted to the point of sale terminal from the remote server. Payment for the items is consummated.

### BRIEF DESCRIPTION OF THE DRAWINGS

FIG. 1 is a diagram of one embodiment of a shopping communications system of the present invention.

FIGS. 2A-2F are flowcharts illustrating exemplary processes for facilitating shopping using one embodiment of the inventive system.

FIGS. 3A-3E show an exemplary web page displaying a user interface that can be used to create a user account.

FIG. 3F depicts an exemplary web page displaying a shopping list of items scanned by a user.

FIG. 3G depicts an exemplary web page illustrating one embodiment of a user interface that can be used to create a shopping list.

FIG. 3H depicts an exemplary web page illustrating another embodiment of a user interface that can be used to create a shopping list.

FIG. 3I depicts an exemplary web page illustrating one embodiment of a user interface through which a user may accept and add specially-featured items to a shopping list.

FIG. 3J depicts an exemplary web page illustrating one embodiment of a user interface that displays a shopping list along with suggested alternatives to the items on the list.

FIGS. 4A-4E show a progression of user interfaces on a wireless scanning device displayed during the creation of a shopping list, in accordance with a preferred embodiment of the present invention.

FIGS. 5A-5D show a progression of user interfaces on a wireless scanning device displayed during creation of a checkout list, in accordance with a preferred embodiment of the present invention.

FIGS. 5E-5G show a progression of user interfaces on a wireless scanning device displayed during a checkout process, in accordance with a preferred embodiment of the present invention.

FIG. 6 illustrates one embodiment of a point of sale terminal including a touch screen terminal that may be used during a checkout process.

FIG. 7A illustrates one embodiment of a data structure used to organize data in accordance with a preferred embodiment of the present invention.

FIGS. 7B-7D illustrate a series of XML statements used to define the structure of data used in connection with a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts and steps. While many of the preferred embodiments are described herein as relating to grocery shopping, it will be understood by those skilled in the art that the invention is equally applicable to any type of shopping experience, including but not limited to grocery shopping.

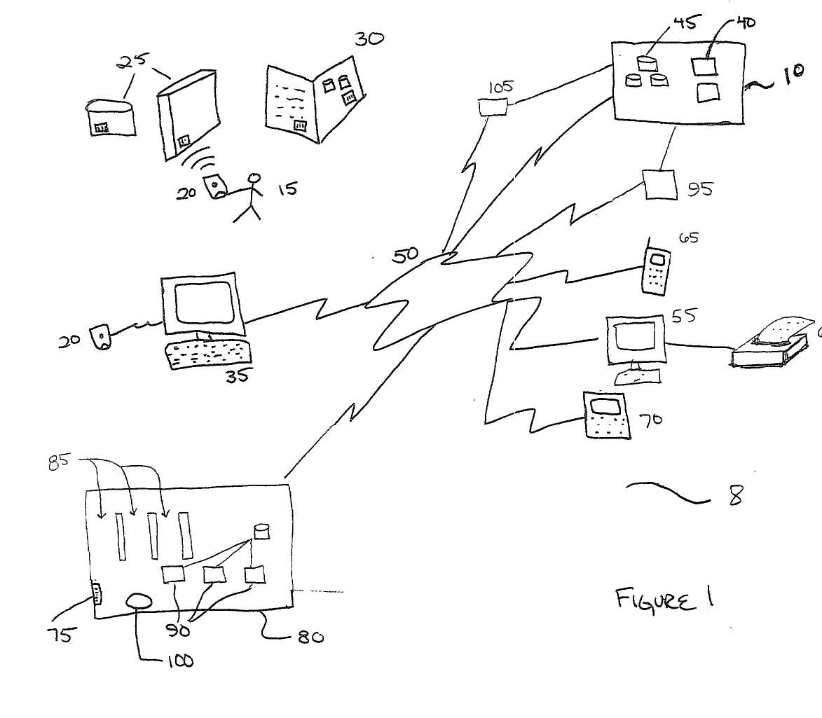

A preferred embodiment of a shopping communications system 8 for facilitating purchase of one or more items in accordance with the present invention is illustrated in FIG. 1. System 8 facilitates purchase of items by allowing end user 15 to conduct traditional shopping activities, such as creating and storing a shopping list or obtaining product information, electronically. Using an electronic device, such as a wireless scanning device 65, personal digital assistant 70, personal computer 35, or other Internet access device 55, the end user 15 can send and receive communications pertaining to shopping from any location (including a store 80, such as a grocery store, or home) via a global communications network (such as, e.g., the Internet 50). System 8 may also include one or more servers 10 (which comprise one or more databases 45 and one or more processors 40), third party service provider 95 for providing shopping services, and/or third party service provider 105 for providing credit services.

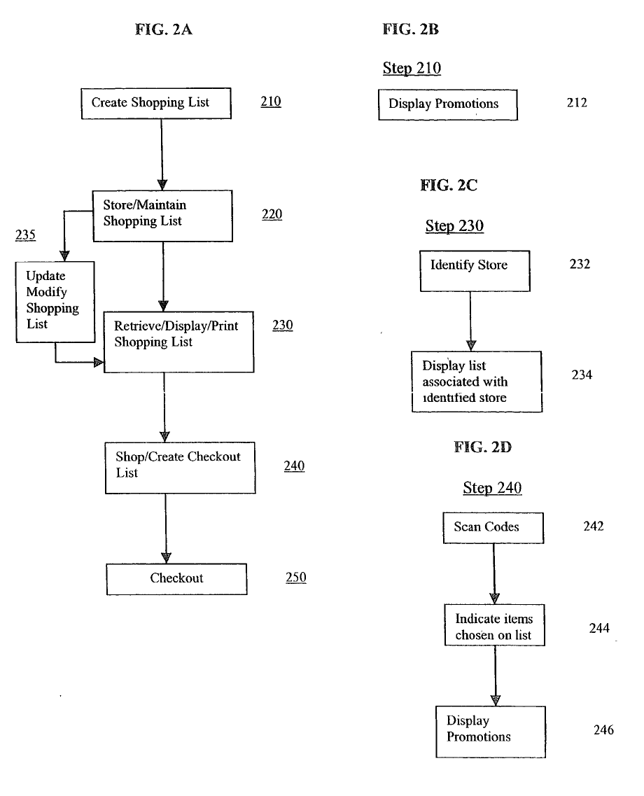

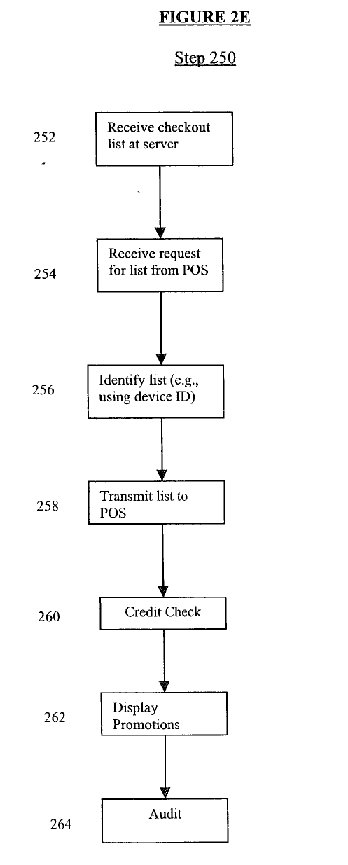

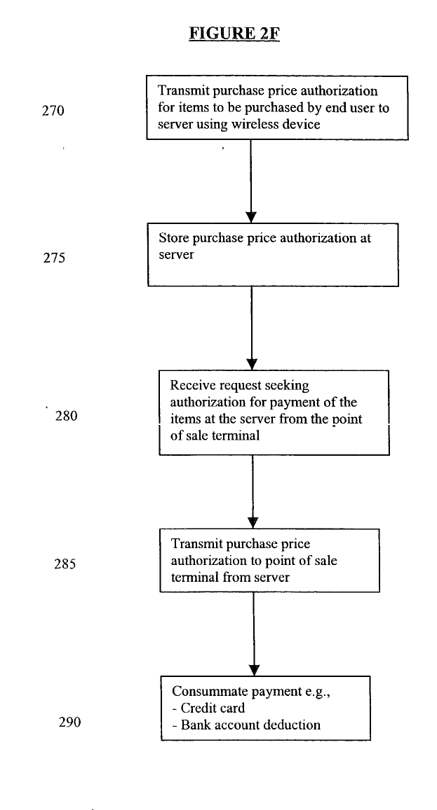

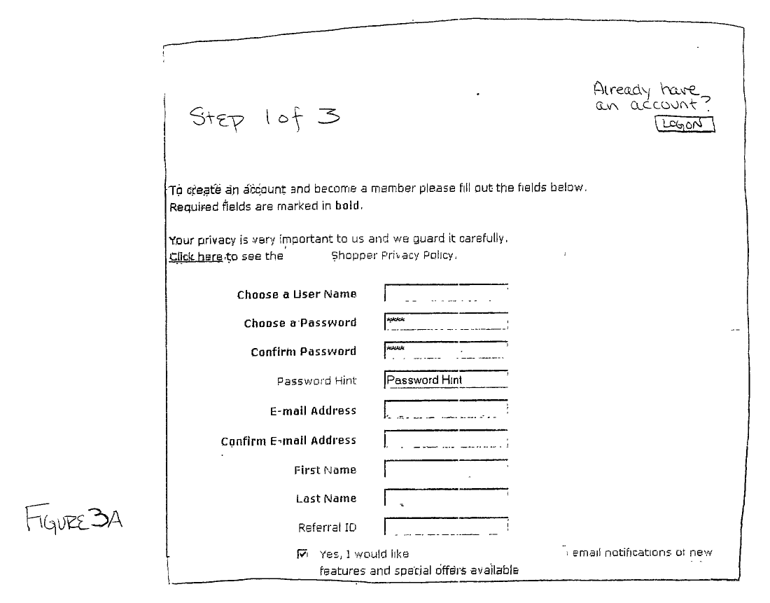

Several flowcharts illustrating preferred embodiments of a method of using system 8 are shown in FIGS. 2A-2F. The process, which is described in detail below, can be summarized as follows. In step 210, shown in FIG. 2A, a shopping list is created in one of several ways. With reference to FIG. 2B, step 210 may include the display of promotions to end user 15 in step 212. In step 220, the shopping list is then stored and maintained in, for example, wireless scanning device 65 or databases 45 of server 10. Once stored, the shopping list can be retrieved, displayed, and/or printed, in step 230 of FIG. 2A. With reference to FIG. 2C, step 230 may include identifying the store in one of several ways, in step 232, and displaying the list associated with the identified store, in step 234. If desired, the shopping list can be updated, in step 235, to reflect any desired changes to the shopping list.

Referring again to FIG. 2A, in step 240, a checkout list is created, which includes all items that the user has exhibited an intent to purchase. With reference to FIG. 2D, step 240 may include scanning codes, in step 242, displaying an indication of items chosen on the checkout list, in step 244, and displaying promotions, in step 246. Returning again to FIG. 2A, in step 250, the end user can check out, using the wireless scanning device 65, through interactions with server 10 and point of sale terminal 90 in store 80. With reference to FIG. 2E, step 250 may include receiving a checkout list at server 10, in step 252. Then, a request for the checkout list is received from the point of sale terminal, in step 254. In step 256, the checkout list is identified (using, e.g., a device identification number). In step 258, the checkout list is transmitted to the point of sale terminal. In some embodiments, a credit check is performed in step 260 and returned along with the checkout list. In still other embodiments, in step 262, promotions may be displayed to the end user at check out. Finally, in some embodiments, in step 264, the transaction is audited.

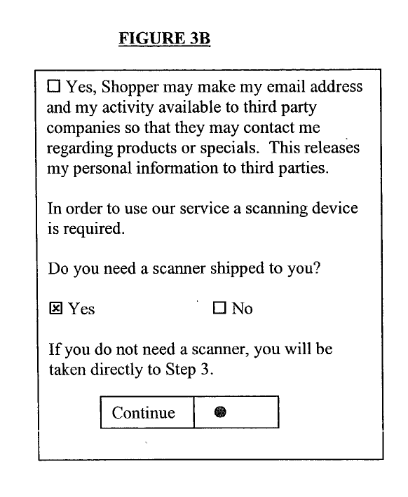

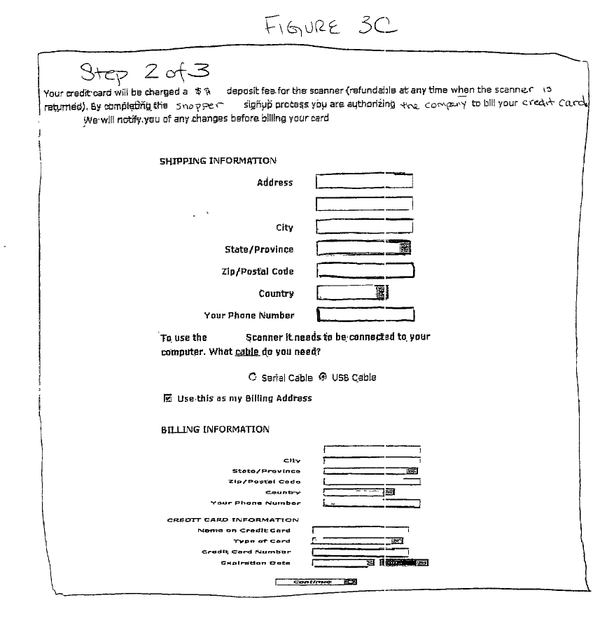

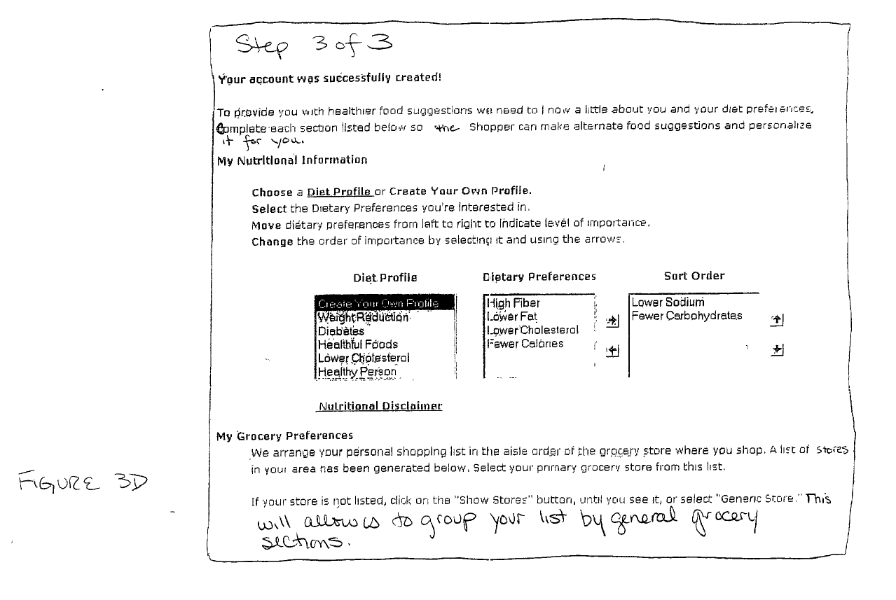

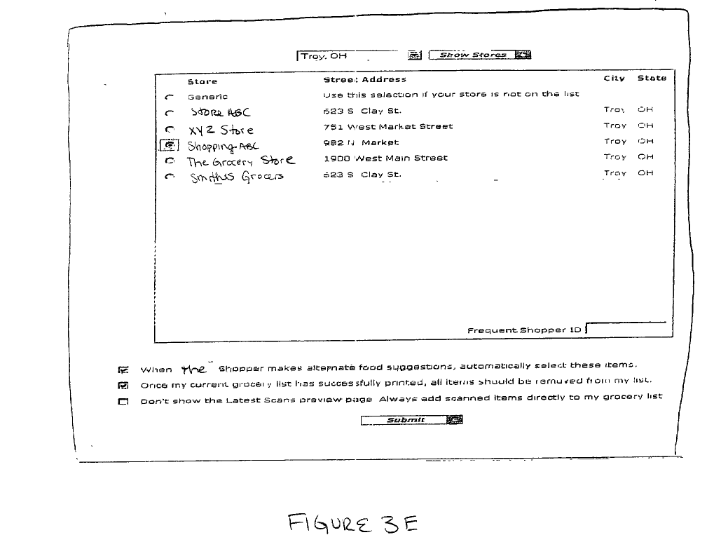

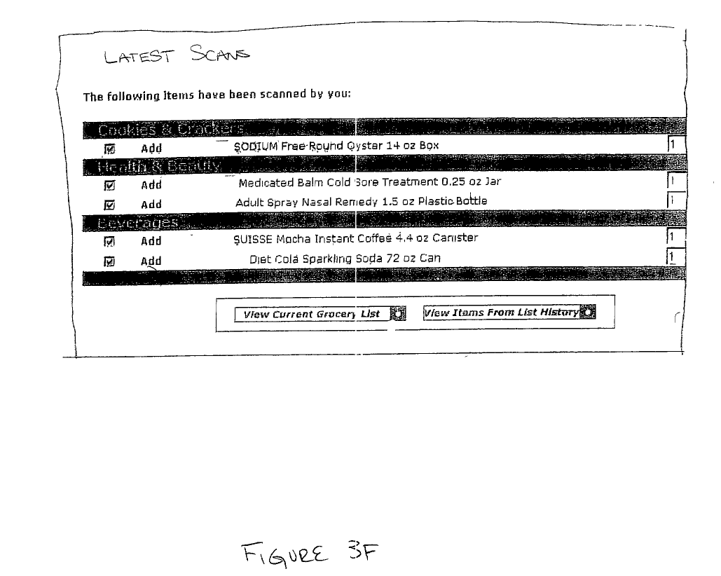

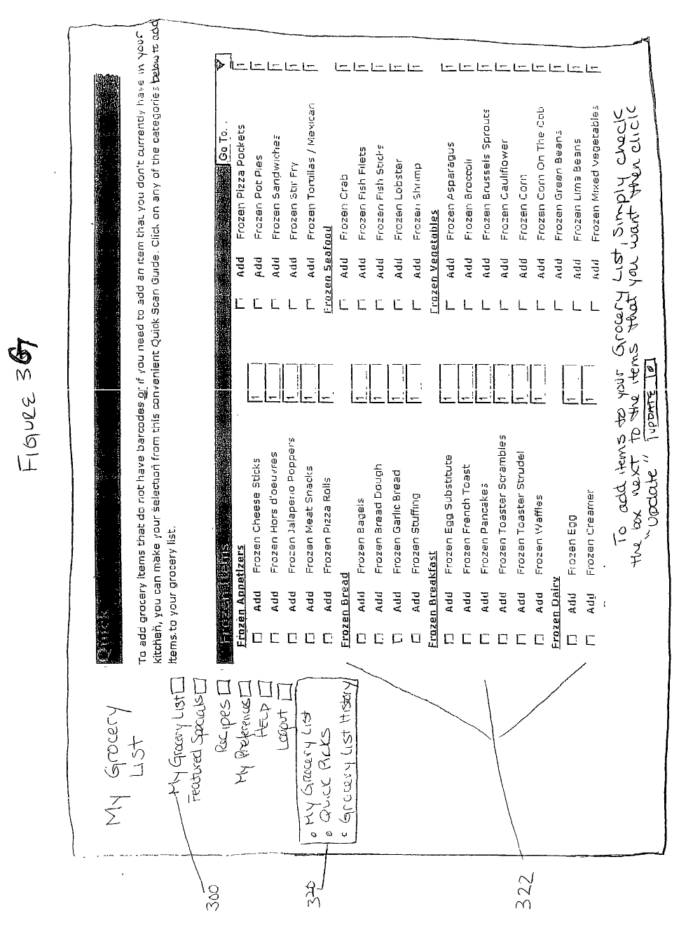

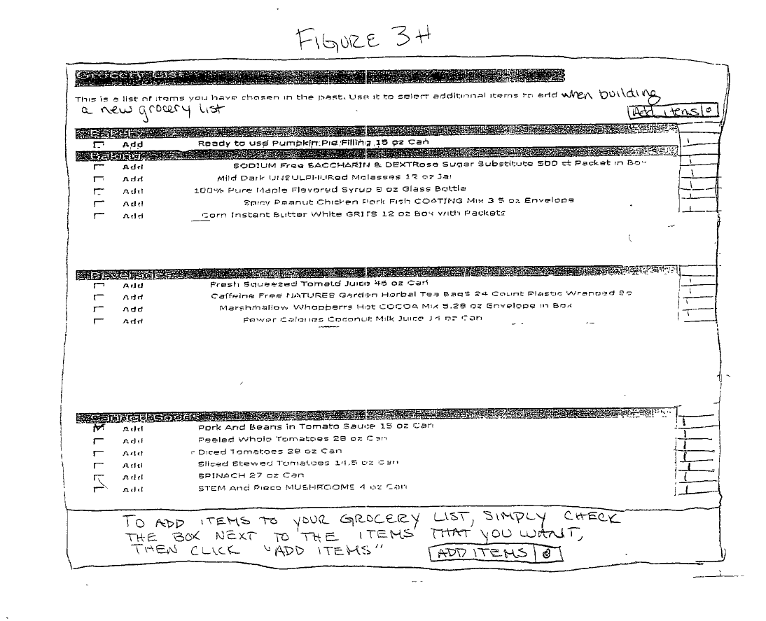

Prior to using system 8, in a preferred embodiment of the invention, end user 15 may be required to set up a user account. Creating a user account can be accomplished by the end user simply by completing an online form, an example of which is shown in FIGS. 3A-3E (depicting web pages that may be used in the grocery shopping embodiment). The end user 15 may employ this user interface to input and send information regarding the end user (such as the end user's contact information and shopping preferences) via the Internet 50 to server 10, where it may be stored in databases 45. This user information may be stored as part of the user's profile and can be used in several ways to facilitate and enhance the end user's shopping experience. For example, as discussed in more detail below, this information can be used to offer certain promotions to a particular user or to create, automatically, a shopping list for a particular user.

After creating a user account, end user 15 may create a shopping list, in step 210. The shopping list can be created in several different ways. In some embodiments, the shopping list is created, not at the store 80, but at the end user's home or other location. For example, with reference to FIG. 1, the end user 15 may employ home scanning device 20 in conjunction with personal computer 35. Using home scanning device 20, the end user 15 may scan the UPC code printed on the packaging of a item 25 or a code associated with a item in a magazine or other booklet 30. After scanning all desired items, the end user 15 may then synchronize the home scanning device 20, on which the scanned codes are stored, with personal computer 35. The codes are transmitted from personal computer 35 to processors 40 at server 10 via the Internet 50. Databases 45 store a registry of codes and corresponding items. In order to create the shopping list, processors 40 consult databases 45 to identify the items associated with the codes scanned and transmitted by end user 15. A user interface showing a portion of a shopping list created in this way is shown in FIG. 3F.

In another embodiment, a shopping list may be created at home or another location using only a personal computer 35. This feature is particularly useful when, for instance, a particular desired item does not include a printed barcode, or the item is not available for scanning (e.g., a box of frozen food consumed and discarded). Using a personal computer 35, the user 15 may log onto system 8 and, using several user interface features provided through a web page, create a shopping list or modify an existing list. For example, as shown in FIG. 3G, after choosing “My Grocery List” tab 300, the end user 15 can create or modify the shopping list by selecting “Quick Picks” tab 320. A variety of grocery items, grouped by common attribute, are then displayed to the end user. The end user 15 can browse through the grocery items, just as she could in an actual store, and add to her shopping list any item she desires by checking any of boxes 322.

In some cases, the end user 15 may want to include on the shopping list items previously selected but, for some reason, are not available for scanning. It is also possible that the end user 15 does not remember the name of the item previously selected. Thus, it may be desirable to provide the end user 15 with the ability to look up grocery items selected in the past. An exemplary user interface, shown in FIG. 3H, displays for the end user 15 previously selected grocery items organized in accordance with a common attribute (e.g., item type). Employing this feature, the end user 15 may select any displayed item to be added to the shopping list.

In still other embodiments, the shopping list may be created automatically based on the preferences of the end user 15. With reference to FIG. 1, server 10 or the third party service provider 95 may select items for inclusion on the shopping list based on items the end user 15 had selected in the past. Such selected items may include, for example, healthy alternatives to items selected in the past. For example, a user interface displaying a shopping list is shown in FIG. 3I. Items on the shopping list selected by the end user are presented along with corresponding suggested alternatives 352. If so desired, end user 15 may delete any item on the list using the appropriate boxes 354 or replace a previously chosen item with the suggested alternative.

In a preferred embodiment of the present invention, promotions or other features may be offered to the end user 15. The particular promotions or features offered may be identified based on information included in the end user's profile (such as, e.g., user preference information collected during initial user account set-up process) or items included on the end user's shopping list. Referring to FIG. 3J, upon logging onto system 8, and clicking on “Featured Specials” tab 340, featured items and promotions may be offered to end user 15. The end user 15 may, if desired, select and add any item to her shopping list by checking the appropriate boxes 342.

These and other ways of obtaining codes associated with grocery items and creating a list of grocery items are described in co-pending U.S. patent application Ser. No. 09/521,244, which is hereby incorporated by reference.

In still other embodiments, the end user 15 may create a shopping list using wireless scanning device 65. It should be noted that wireless scanning device 65 maybe any device that is capable of storing and processing data, scanning bar codes and maintaining a wireless Internet connection. Thus, instead of using a combination of home scanning device 20 and personal computer 35, or personal computer 35 alone, wireless scanning device 65 can be used both to create a shopping list and to connect to the system 8 for data transmission, as discussed in more detail below.

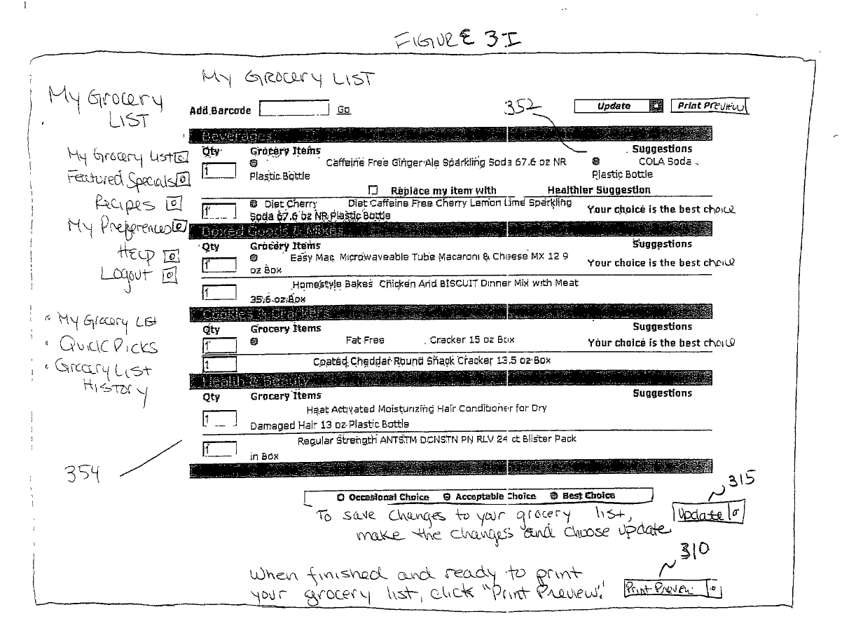

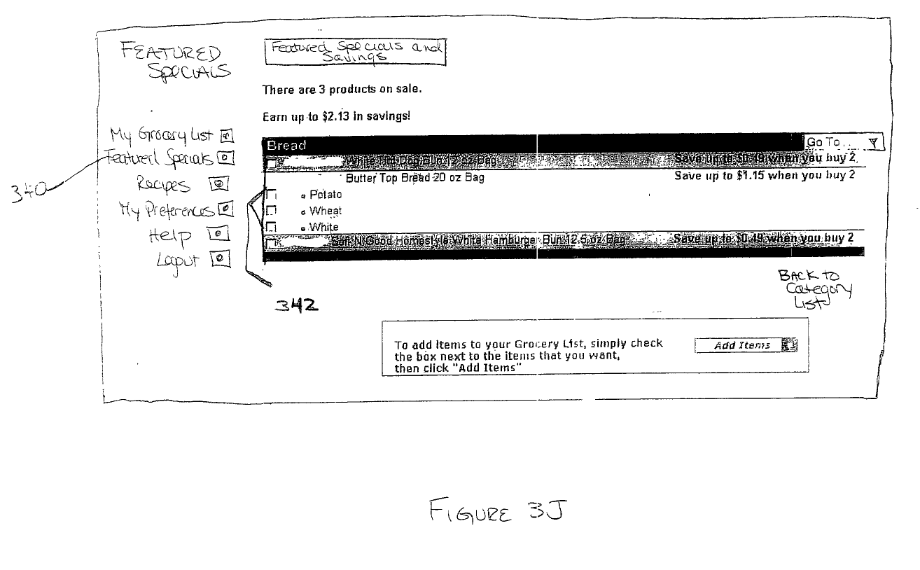

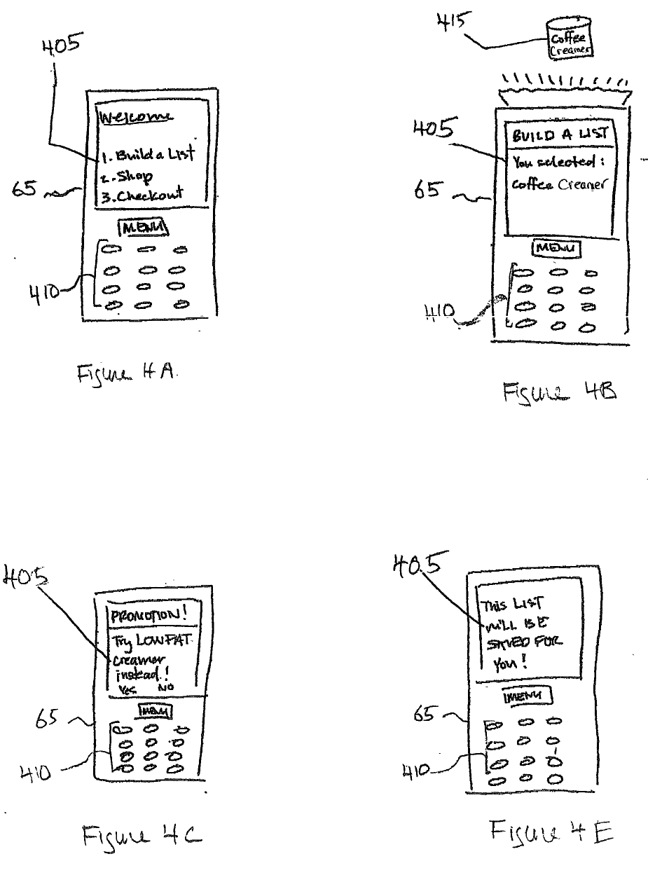

FIGS. 4A through 4D illustrate the manner in which an end user 15 may create a shopping list using a wireless scanning device 65. With reference to FIG. 4A, the end user 15 may commence creation of a shopping list by selecting the build-a-list option using keypad 410. Upon selecting this option, the end user 15 can add an item to her shopping list by scanning an item 415 with wireless scanning device 65, as shown in FIG. 4B. Alternatively, using the keypad 410, the code associated with item 415 may be entered manually. Upon selecting an item by either scanning or manual entry, the wireless scanning device 65 may confirm the item selection on the display 405.

In some embodiments, where the wireless scanning device 65 maintains a live Internet connection to the third party service provider 95 or processors 40 during creation of the shopping list, end user 15 may be presented with healthy alternatives or promotions relating to the selected items (as described in more detail above with respect to FIG. 3I) as she creates her list. For example, as shown in FIG. 4C, after the end user 15 scans an item 415, a healthy alternative to item 415 (i.e., a low fat creamer) may be displayed. In another example, the end user 15 may have indicated an intent to purchase one can of a particular vegetable by scanning the item. If the particular can of vegetable is on sale at that time for 3 cans for $1.00, the end user 15 may be presented with a promotion indicating the sale and asking the end user 15 if she wishes to include two more cans on her list, as illustrated in FIG. 4D.

With reference to FIG. 2, after a shopping list is created in step 210, it is stored and maintained electronically, in step 220. Referring back to FIG. 1, the end user 15 can transmit the shopping list, via the Internet 50, to the server 10 and store the list in databases 45. Alternatively, as illustrated in FIG. 4E, the shopping list can be saved and stored in the memory of the wireless scanning device 65.

Referring again to FIG. 2, in step 230, a shopping list stored in databases 45 can be retrieved and/or accessed, via the Internet 50, using an electronic communication device. For example, with reference to FIG. 1, the end user 15 can log onto the system 8 using personal computer 35 and view the entire shopping list, as shown in FIG. 3I, by selecting the “Current Grocery List” tab 300. If desired, the end user 15 can print the list by clicking on “Print Preview” tab 310. In some embodiments, the shopping list may be updated (step 235 of FIG. 2) prior to printing by checking appropriate item boxes and clicking on “Update” tab 315. By way of further example, the end user 15 may employ an Internet access device 55 (which may be a personal computer or hand held computing device, for example) to connect to server 10 via the Internet 50, retrieve the shopping list, and print the list on printer 60. Internet access device 55 and printer 60 may be maintained at any location, such as grocery store 80. The end user 15 may also connect to server 10 and download the shopping list from an Internet-enabled wireless portable computer, such as a personal digital assistant 70.

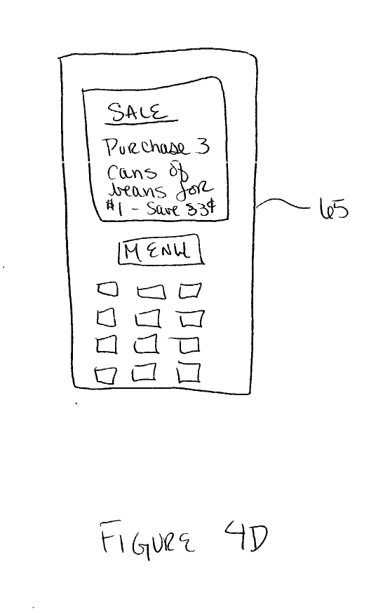

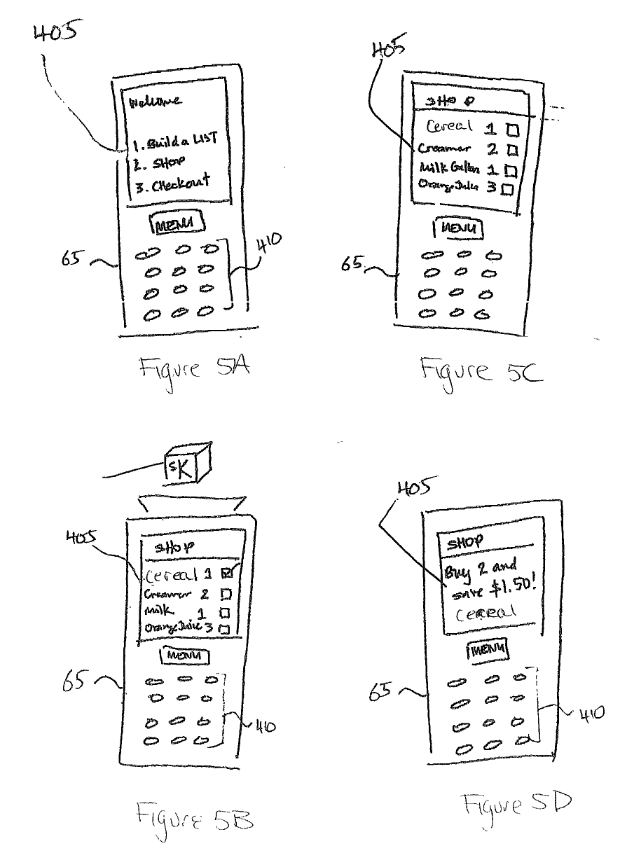

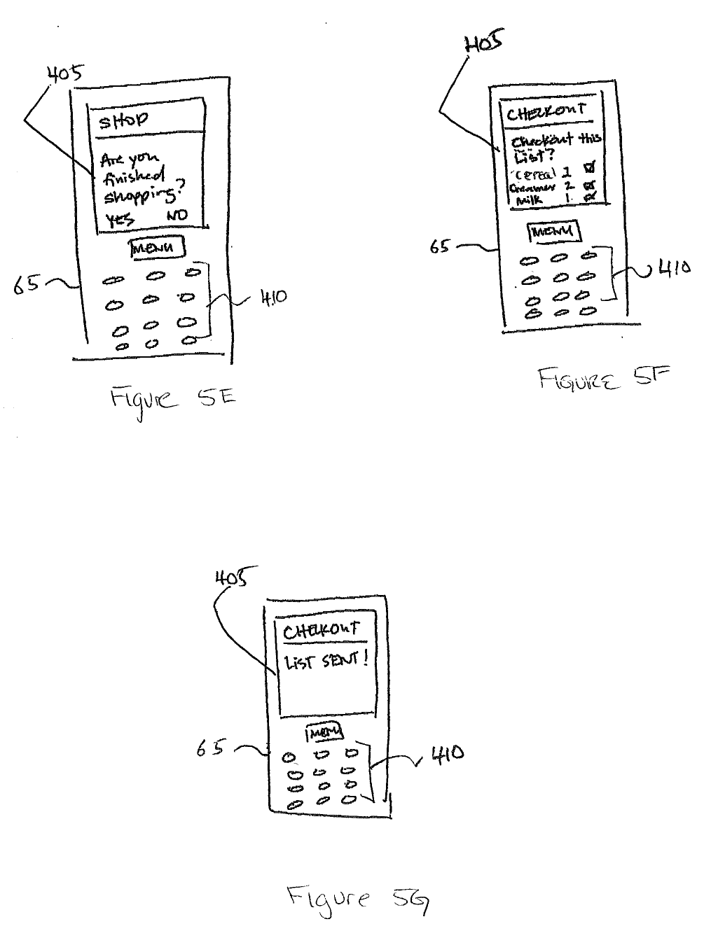

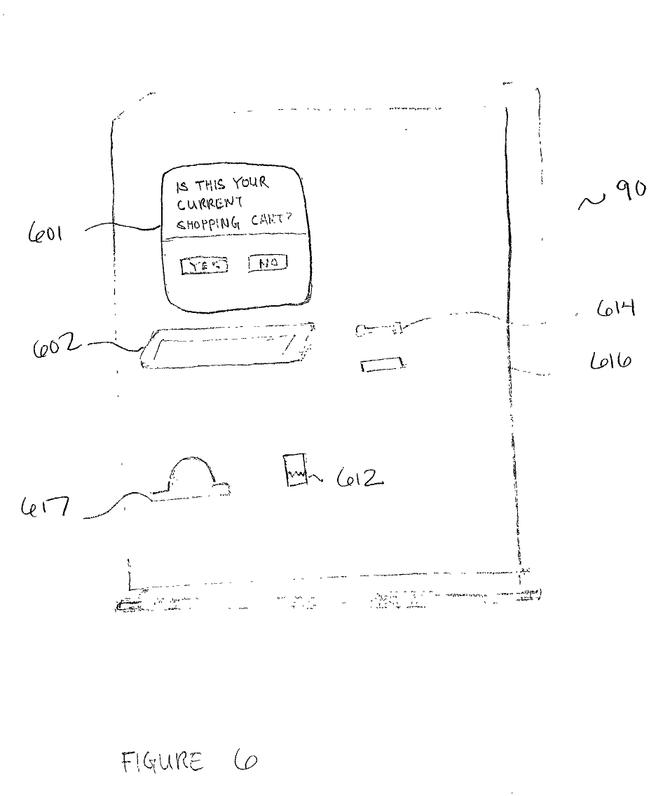

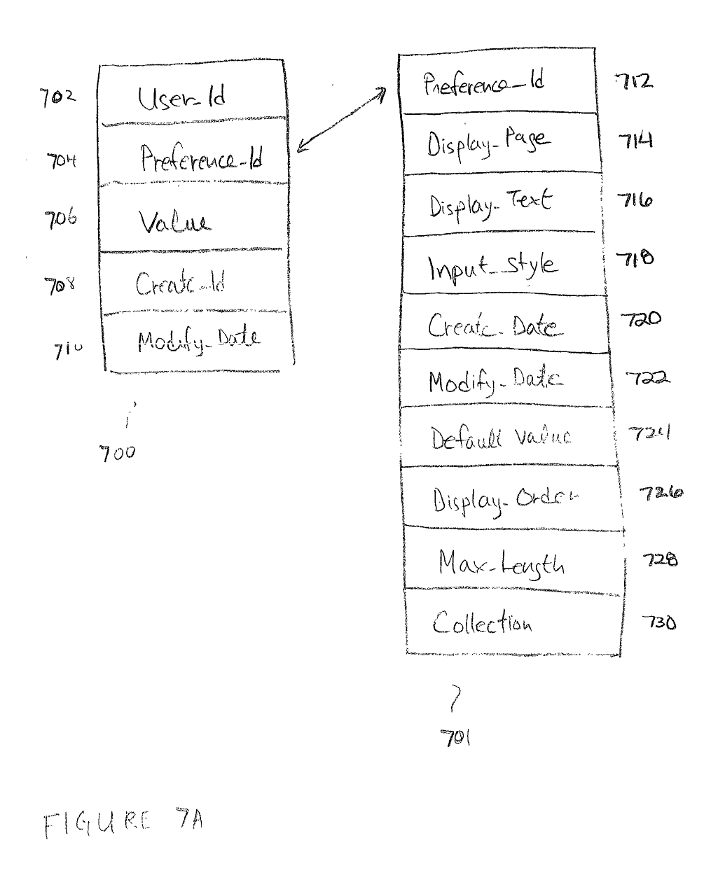

In still other embodiments, wireless scanning device 65 can be used to retrieve the shopping list. For instance, end user 15 can connect to the server 10 via the Internet 50 using wireless scanning device 65 and retrieve the shopping list stored in database 45. With reference to FIG. 5A, upon selecting “Shop” option on wireless scanning device 65, the end user 15 may be presented with a shopping list previously created, shown in FIG. 5B. It will be apparent that while in some embodiments the shopping list is retrieved from databases 45 via the Internet 50, in other embodiments the shopping list is retrieved directly from the memory of the wireless scanning device 65.

In some embodiments, the shopping list retrieved by the end user 15 may be tailored to the particular grocery store 80 in which the end user 15 intends to shop. The intended grocery store 80 may be identified by end user 15 in any one of a number of ways. For example, with reference to FIG. 1, in some embodiments, end user 15 scans a code 75 (such as a bar code) at the entrance to store 80 using wireless scanning device 65. The code is transmitted via the Internet 50 to server 10. Server 10 consults databases 45, which maintain a registry identifying stores and their associated codes. Using this registry and the code transmitted, the end user's intended store 80 is identified. Other ways of identifying the store 80 will be known to those skilled in the art and are within the scope of the present invention.

In still other embodiments, the grocery items on the shopping list retrieved may be arranged in an order corresponding to the location of the grocery items in the aisles 85 of the identified store 80. Thus, for example, the items on the shopping list shown in FIG. 5B may be arranged in the order in which such items can be found in the particular store. These and other ways of tailoring the shopping list for the identified store 80 are described in pending U.S. patent application Ser. No. 09/521,244, which was previously incorporated herein by reference.

The end user 15 may commence shopping using wireless scanning device 65, in step 240 of FIG. 2. In accordance with the present invention, the end user 15 may commence shopping using wireless scanning device 65 without previously interacting with system 8 or its functionality in any way. In particular, for example, the end user 15 need not have set up a user account, created a shopping list, stored a shopping list and/or retrieved a shopping list (as described previously herein) prior to commencing shopping within the scope of the present invention.

In some embodiments, wireless scanning device 65 maintains a live Internet connection during the entire shopping experience. However, cellular coverage in a typical grocery store is weak, spotty or non-existent in locations other than at the front of the store. Thus, in order to ensure a connection throughout the store, in-store wireless networks must be implemented. While such systems have some advantages (e.g., real-time interactivity between the end user 15 and wireless scanning device 65, on the one hand, and server 10, on the other hand), they are expensive to implement and maintain. In addition, the end user 15 typically will be required to account to her wireless service provider for the air time minutes used during the entire shopping experience. Thus, in the preferred embodiment, a live Internet connection is maintained only until the end user 15 downloads the shopping list onto the wireless scanning device 65.

While shopping using wireless scanning device 65, end user 15 creates a checkout list of items by traversing aisles 85 (shown in FIG. 1) and scanning codes on selected items, corresponding to items on the shopping list displayed on wireless scanning device 65. The end user 15 may then physically load each scanned item into her shopping cart. In some embodiments, as shown in FIG. 5C, upon scanning the code on one of the selected items, an indication may be made on display 405 that one of the items on the shopping list was chosen for intended purchase.

In some embodiments, promotions (e.g., coupons, specials, discounts, suggestions, and other information) related to the items on the shopping list may be shown on display 405 of wireless scanning device 65 during the creation of the checkout list. For instance, as shown in FIG. 5D, promotional information is shown on the display 405. The promotional information may, in some embodiments, be related to the particular store 80 identified by the end user 15. In other embodiments, end user 15 may indicate that she does not wish to receive any promotions. This user preference may be stored in databases 45 (and associated with, for example, the end user 15 or the wireless scanning device 65 employed by end user 15) and consulted by processors 40 prior to presenting any promotions.

As is apparent from the foregoing description, in the preferred embodiment, the wireless scanning device 65 may download from databases 45 and store a variety of different types of information that may be useful to the end user 15 during her shopping experience including, by way of example, data relating to the identity of the store 80; the aisle 85 layout of store 80; the identity of the items on the shopping list and associated codes; substitutes and alternatives for the items on the shopping list, including nutritional information in the grocery shopping embodiment; promotional information; and other product information.

Upon completing her review of aisles 85, and creating a checkout list, end user 15 may then proceed to check out, in step 250 of FIG. 2. With reference to FIG. 5E, the user may be presented with a request that she confirm her desire to finish shopping. After confirming the same, the end user may be asked to identify and confirm the intended checkout list, as shown in FIG. 5F. As shown in FIG. 5G, upon satisfactorily confirming the intended checkout list, the end user 15 may transmit the list to server 10 via Internet 50. In embodiments in which the end user 15 does not maintain a live Internet connection during shopping, the end user 15 will be required to reconnect to the Internet at this point.

Upon transmitting the scanned codes to server 10 via the Internet 50, the items on the checkout list selected for purchase are identified using databases 45. This checkout list is stored in databases 45 and associated with, for example, the end user 15 or wireless scanning device 65 from which the codes were transmitted (using, e.g., an identification number).

End user 15 may then approach any one of point of sale terminals 90 (shown in FIG. 1) and initiate a transaction. As shown in FIG. 1, the location at which the items are scanned (e.g., aisles 85) is different from the location of point of sale terminals 90 (i.e., a location in the store 80 where goods on the checkout list may be purchased using the wireless scanning device 65). In the preferred embodiment, point of sale terminals 90 are equipped for self check out (i.e., to allow the end user 15 to checkout without need for a cashier).

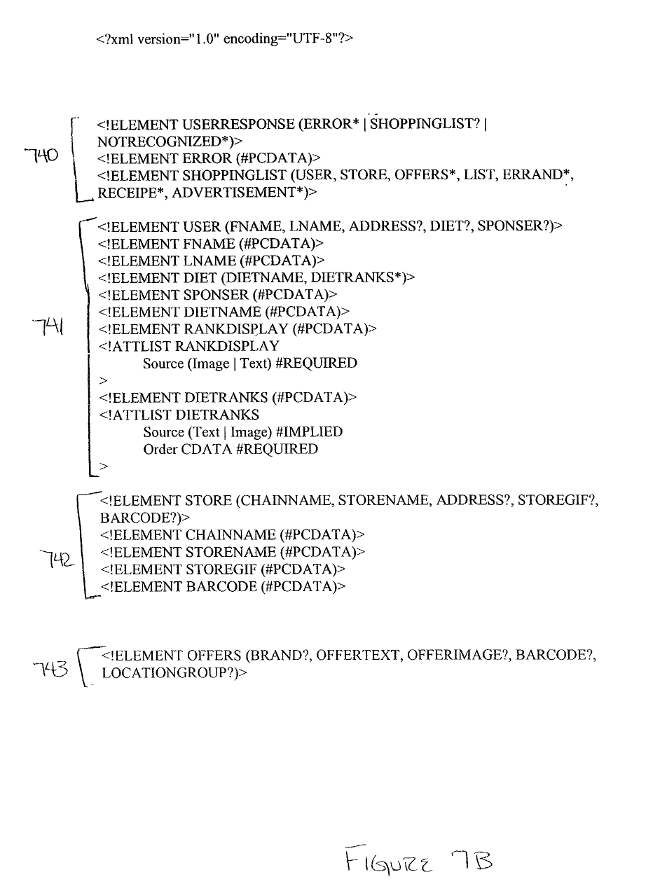

With reference to FIG. 6, the transaction may be initiated by the end user 15 using a touch screen 601 or cash register number pad 602 at point of sale terminal 90. Upon initiating the transaction, point of sale terminal 90 connects to server 10 via the Internet 50. End user 15 then enters data at point of sale terminal 90 to identify and request the checkout list in which she is interested. Identifying the checkout list can be accomplished in any one of a number of ways. For example, end user 15 may input her personal identification number or that of wireless scanning device 65 with which the checkout list is associated. In one embodiment, the identification number of wireless scanning device 65 may be inputted using the keypad 602 on the point of sale terminal 90. In another embodiment, the identification number can be inputted by scanning a bar code (representing the identification number) on wireless scanning device 65 using a barcode reader 617 at the point of sale terminal 90.

Upon receiving the information for identifying the checkout list and the request for the checkout list from point of sale terminal 90, processors 40 consult databases 45, identify the appropriate checkout list, and transmit it back to point of sale terminal 90. The information transmitted from server 10 to point of sale terminal 90 is, in the preferred embodiment, encrypted and formatted to match display needs of point of sale terminal 90. Point of sale terminal 90 then processes the retrieved checkout list in a conventional manner, known to those skilled in the art, as if the items on the list were scanned at the point of sale terminal 90 by a cashier or end user 15.

As in a conventional transaction, end user 15 will be able to view the items on the checkout list and pay for the items with any tender accepted by the point of sale terminal 90. The end user 15 may be presented with an option relating to the method of payment (e.g., cash, credit or debit). If either the credit or debit option is chosen, the end user 15 will be required to swipe the card through card reader 614 situated at the point of sale terminal 90. If the cash option is chosen, end user 15 may proceed by inserting an appropriate amount of cash into a cash dispenser/acceptor 616 situated on the point of sale terminal 90. If necessary, any change is returned to end user 15 through the cash dispenser/acceptor 616. End user 15 has, thus, completed the check out process and a receipt is dispensed from receipt dispenser 612 located on the point of sale terminal 90.

As an alternative to paying for items selected for purchase in a conventional manner (e.g., cash payment to a cashier or swiping a credit or debit card at the point of sale terminal 90), payment may be made in accordance with a method of the present invention. With reference to FIG. 2F, in step 270, a purchase price authorization for the items to be purchased is transmitted over a global communications network (e.g., the Internet) by the end user 15 to server 10 using a wireless device, such as a mobile phone, a PDA or other wireless device that can accept user input. The purchase price authorization includes some manner of identifying the end user 15 (e.g., an end user 15 identification number or a wireless device identification number) and price information (i.e., the total amount due for the items selected for purchase). The purchase price authorization is stored at server 10, in step 275. In step 280, a request seeking authorization for payment of the items selected for purchase is received at the server 10 from the point of sale terminal 90. The request includes the end user identification information and the price information, thereby allowing server 10 to identify the purchase price authorization previously provided by the end user 15. In step 285, the purchase price authorization is transmitted to the point of sale terminal 90 from the server 10. In step 290, payment for the items is consummated. In one embodiment, in step 285, the server 10 transmits to the point of sale terminal 90 an end user credit card number. In this embodiment, step 290 includes charging the end user's credit card for the amounts due. In an alternative embodiment, step 290 includes deducting the amounts due from a bank account of the end user.

In some embodiments, the transaction may be audited in a variety of different ways. Some prior art methods of auditing the transaction employ use of cameras to monitor the shopper's activity. Other prior art methods employ scales to weigh the cart of the end user 15 and its contents and compare that weight to what the cart should weigh based on the items scanned by end user 15. In accordance with a preferred embodiment of the present invention, a human store monitor 100 is provided, as illustrated in FIG. 1. Monitor 100 may randomly select one, several or all item(s) in the cart of end user 15, scan the item(s), and determine if the item(s) is on the checkout list of the end user. This auditing may occur at any level of frequency within the scope of the present invention (i.e., every time the end user 15 makes a purchase, once every few times the end user 15 makes a purchase, etc.). The results of each audit for each end user 15 may be stored, for example, at server 10.

In some aspects of the invention, server 10 may maintain or obtain from a third party service provider 105 a credit rating, for the end user 15 during checkout. The credit rating includes, in the preferred embodiment, the audit history of the end user 15, maintained as described above. This credit rating may be provided to the store 80 along with the checkout list of the end user 15 to assist the store 80 in determining whether it should consummate the transaction with end user 15. For example, if store 80 learns each audit of the end user 15 returned a positive result (e.g., all items in the cart of the end user 15 were included on the checkout list), the store 80 will consummate the transaction with end user 15.

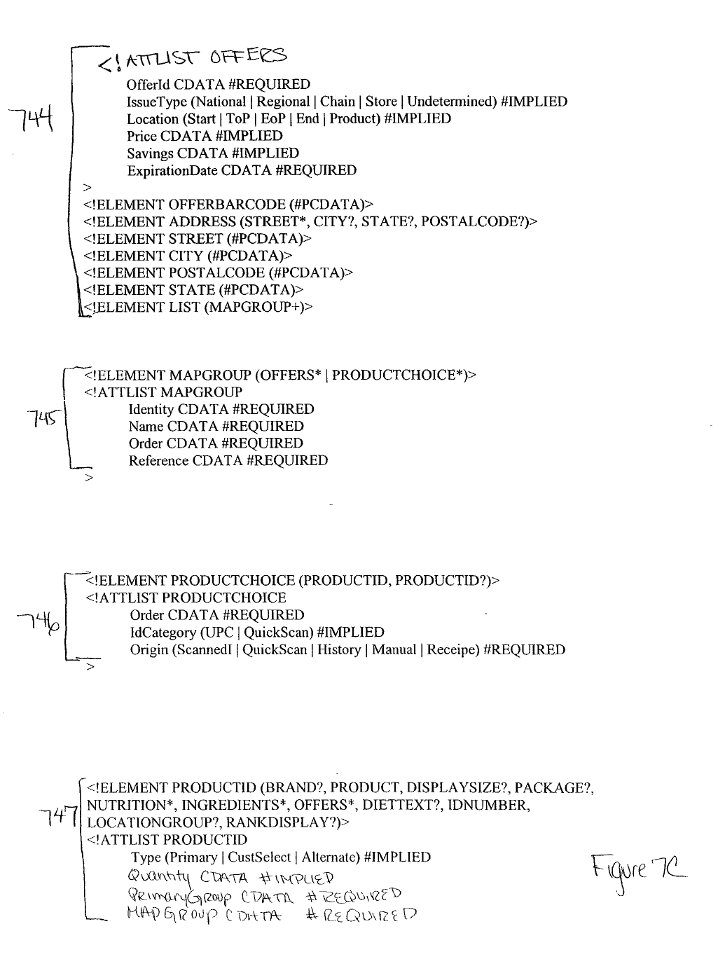

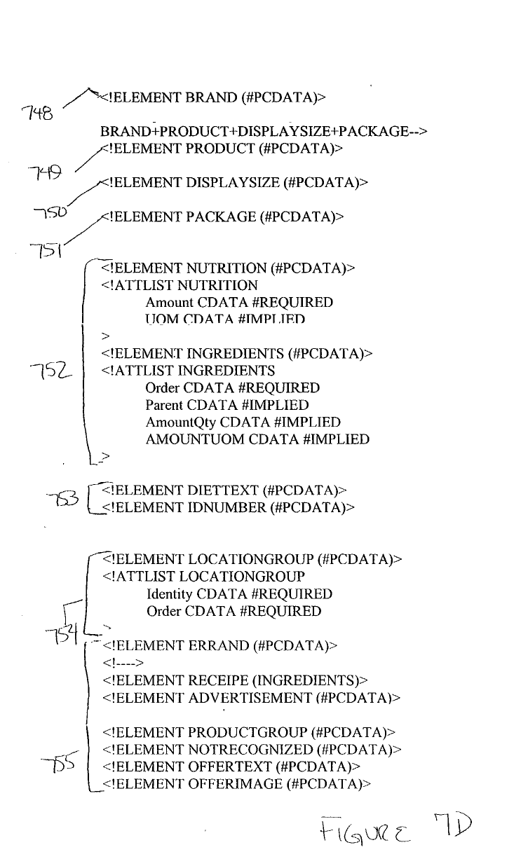

As is apparent from the foregoing description, various aspects of the inventive system may be implemented through use of databases 45. For example, with reference to FIG. 7A, User Preference table 700 illustrates the manner in which specific user preferences relating to receiving promotions may be maintained. Preferences table 701 illustrates the manner in which promotions relating to particular user preferences may be maintained. Thus, for a given user (identified by User_ID field 702), a user preference (Preference_Id field 704) can be identified. Referring to Preferences table 701, the various attributes for the identified user preference can then be identified.

FIGS. 7B through 7D illustrate a series of exemplary XML statements that may similarly be used to organize data used in connection with the inventive system. For example, statements 740 may be used to identify the document type (i.e., shopping list). Statements 741 may be used to define user attributes. Statements 742 may be used to maintain store display information. Statements 743 may be used to define certain savings or promotions offered to the end user. Statements 744 may be used to define attributes of offers. Statements 745 may be used to define groupings for a given list of end user product choices. Statements 746 may be used to maintain items on the end user's shopping list (either products selected by the end user or recommended by the system 8). Statements 747 may be used to define additional product information. Statements 748, 749, 750, 751 and 752 may be used to display and/or identify the brand, name, size, packaging, and nutritional information, respectively, of a product on the shopping list. Statements 753 may be used to define information relating to a particular diet of an end user. Statements 754 may be used to define the location of particular items in a store. Thus, based on an identified location of an item in a store (identified in statements 754), particular offers (ELEMENT OFFERS in statement 743) may be presented to the end user. Statements 755 may be used to define the mapping category used by system 8 for particular products.

Although the foregoing description is directed to the preferred embodiments of the invention, it is noted that other variations and modifications will be apparent to those skilled in the art, and may be made without departing from the spirit or scope of the invention.

What is claimed is:

1. In a system comprising a wireless scanning device that connects to a server via a global communications network, a method for facilitating purchase of one or more items on a shopping list maintained on the server, the method comprising:
displaying the shopping list on the wireless scanning device; and
creating, using the wireless scanning device and the shopping list, a checkout list by scanning codes on selected items at locations proximate the selected items in a store;
wherein one or more of the locations proximate the selected items corresponds to a location that is different from a point of sale in the store, said point of sale corresponding to a location in the store where goods on the checkout list are purchased using the wireless scanning device.

2. The method of claim 1 further comprising:
facilitating indication on the shopping list that one of the items was chosen upon scanning the code on one of the selected items.

3. The method of claim 1 further comprising:
displaying on the wireless scanning device promotions related to the items.

4. The method of claim 3 wherein the promotions are related to a prior end-user item selection.

5. The method of claim 1 further comprising:
displaying on the wireless scanning device promotions related to the selected items at one of the locations proximate one of the selected items.

6. The method of claim 1 further comprising:
displaying on the wireless scanning device promotions related to the selected items at the point of sale.

7. The method of claim 1 wherein the items on the shopping list are chosen by the end user.

8. The method of claim 1 wherein the items on the shopping list are chosen for the end user.

9. The method of claim 8 wherein the items are chosen for the end user based on prior item selections of the end user.

10. The method of claim 8 wherein the items chosen for the end user comprise healthy alternatives to prior item selections of the end user.

11. The method of claim 1 wherein the items on the shopping list are arranged in an order corresponding to a location of the items in a user preferred store.

12. The method of claim 1 further comprising:
facilitating identification of the store based on a store code scanned at an entrance to the store.

13. The method of claim 12 wherein the shopping list is associated with the identified store.

14. The method of claim 1 wherein purchasing the goods on the checkout list comprises:
receiving the checkout list at the server from the wireless scanning device;
receiving at the server a request for the checkout list from a point of sale terminal; and
transmitting the checkout list to the point of sale terminal.

15. The method of claim 14 further comprising:
identifying the checkout list transmitted using a wireless scanning device identifier.

16. The method of claim 1 further comprising:
auditing the transaction using a human store monitor.

17. The method of claim 1 further comprising:
providing a credit rating for the end user.

18. A system for facilitating purchase of one or more items on a shopping list comprising:
one or more servers that maintain the shopping list; and
a wireless scanning devices that connect to the server via a global communications network;
wherein the shopping list is displayed on the wireless scanning device;
wherein, using the wireless scanning device and the shopping list, a checkout list is created by scanning codes on selected items at locations proximate the selected items in a store; and
wherein one or more of the locations proximate the selected items corresponds to a location that is different from a point of sale in the store, said point of sale corresponding to a location in the store where goods on the checkout list are purchased using the wireless scanning device.

19. In a system comprising a wireless device of an end user, a point of sale terminal and a remote server, a method of facilitating payment for one or more items selected for purchase, the method comprising:
receiving at the remote server from the end user employing the wireless device over a global communications network a purchase price authorization for the items, the purchase price authorization comprising end user identification information and price information;
storing at the remote server the purchase price authorization;
receiving at the remote server from the point of sale terminal a request for payment authorization, the request comprising the end user identification information and the price information;
transmitting to the point of sale terminal from the remote server the purchase price authorization; and
consummating the payment for the items.

20. The method of claim 19 further comprising:
transmitting to the point of sale terminal from the remote server an end user credit card number,
wherein consummating the payment for the items comprises charging the credit card number an amount comprising the price information.

21. The method of claim 19 wherein consummating the payment for the items comprises deducting an amount comprising the price information from a bank account of the end user.

22. The method of claim 19 wherein the end user identification information comprises wireless device identification information.

23. A system for facilitating payment for one or more items selected for purchase comprising:
a wireless device of an end user;
a point of sale terminal; and
a remote server that receives from the end user employing the wireless device over a communications network a purchase price authorization for the items, the purchase price authorization comprising end user identification information and price information; stores the purchase price authorization; receives from the point of sale terminal a request for payment authorization, the request comprising the end user identification information and the price information; and transmits to the point of sale terminal the purchase price authorization;
wherein the payment for the items is consummated at the point of sale terminal.
